(19) United States
(12) Patent Application Publication
(10) Pub. No.: US 2013/0059268 A1
(43) Pub. Date: Mar. 7, 2013

(54) SYSTEM AND METHODS FOR REMOVING A LOOSE TOOTH

(71) Applicant: Colton Crane, Lander, WY (US)

(72) Inventor: Colton Crane, Lander, WY (US)

(21) Appl. No.: 13/665,111

(22) Filed: Oct. 31, 2012

Related U.S. Application Data
(63) Continuation-in-part of application No. 13/105,810, filed on May 11, 2011.
(60) Provisional application No. 61/641,171, filed on May 1, 2012.
(60) Provisional application No. 61/333,981, filed on May 12, 2010.

(51) Int. Cl. A61C 3/14; B23P 17/04

(52) U.S. Cl. 433/141; 29/896.1

(57) ABSTRACT

A device for removing a loose tooth, the device including a handle, a base structure, and a retention strap, wherein the retention strap is secured about an outer surface of the loose tooth such that the base structure forms an interface with the tooth. The device further including features for increasing friction between the base structure and the tooth to prevent slippage while removing the tooth with the device.

### RELATED APPLICATIONS

This application claims priority to U.S. Provisional Application Ser. No. 61/641,171, entitled SYSTEM AND METHODS FOR REMOVING A LOOSE TOOTH, filed on May 1, 2012, which is incorporated herein in its entirety. This application is further a continuation-in-part of U.S. patent application Ser. No. 13/105,810, entitled SYSTEMS AND METHODS FOR REMOVING A LOOSE TOOTH, filed on May 11, 2011 which claims priority to U.S. Provisional Patent Application Ser. No. 61/333,981, entitled SYSTEMS AND METHODS FOR REMOVING A LOOSE TOOTH, filed on May 12, 2010, each of which is incorporated herein in their entireties.

### BACKGROUND OF THE INVENTION

The present invention relates to systems and methods for removing a loose tooth. In particular, the present invention relates to a device configured to secure a user's grip on a loose tooth thereby assisting the user in removing the tooth from the oral cavity.

It is well known that when children are losing their baby teeth, the shedding of each tooth is more than likely to involve several days of discomfort, peevishness, and difficulty of eating on the part of the child. During this period, the tooth is so loose that each time anything touches the tooth, it tilts about and hurts the adjacent gums.

Attempts of parents to dislodge the tooth with the fingers during this period are usually unsuccessful, as the sizes and locations of the teeth usually make it very difficult to grasp the tooth with the fingers for a straight or slightly twisting pull. Further, as the parents are afraid of hurting the child, they refrain from the painful process of forcing the tooth forward or backward to break it from the gum.

At one time or another, most parents have tried to remove such loose baby teeth by attempting to tie a string or thread (such as dental floss) about the tooth to enable it to be pulled voluntarily by the child. Alternatively, parents attempt to tie the other end of the string to a door-knob or other object which, when put into motion, is supposed to extract the tooth without volition of the child. However, this procedure is rarely successful, as the shape of the baby teeth is such that knotted threads have the habit of sliding off the tooth. Further, few people know how to tie knots sufficiently tight to grip the tooth without pinching the tender gums adjacent to the tooth. Additionally, while working with the loose tooth there is a propensity for the string to become bloody and covered with saliva thereby causing the string to become slippery and difficult to handle.

Thus, while methods exist to assist in removing loose baby teeth, challenges still exist. Accordingly, it would be an improvement in the art to augment or even replace current techniques with other techniques.

### BRIEF SUMMARY OF THE INVENTION

The present invention relates to systems and methods for removing a loose tooth. In particular, the present invention relates to a device configured to secure a user's grip on a loose tooth thereby assisting the user in removing the tooth from the oral cavity. In some implementations, a tooth removal device is provided whereby a user utilized the device to secure a grip on the loose tooth preparatory to removing the loose tooth.

A tooth removal device in accordance with the present invention may include a tubular handle having a first end whereby the user grips the device, and a second end having a base structure against which the loose tooth is held. In some implementations, a retention strap or string is further provided whereby the user secured the base structure against the tooth.

In some implementations, the retention strap forms a loop at the second end of the tubular handle. The retention strap is configured such that the loop is fitted about the loose tooth. A free end of the retention strap extends through the tubular handle exiting an opening located at the first end of the handle. A user adjusts the size and tension of the retention strap by withdrawing the free end from the first end of the handle. Thus, the loop acts as a snare or noose whereby the user is able to secure the tooth to the base structure by reducing the diameter of the loop around the outer diameter of the tooth.

In some implementations, the base structure of the tooth removal device includes a shape or contour configured to accommodate an outer shape or contour of the loose tooth. In other implementations, an interface surface of the base structure includes a texture or material whose function is to increase friction between the base structure and the tooth. For example, in some implementations the interface surface includes a moldable material, such as a plastic or wax that may be prepared by the user to conform to the shape of the loose tooth. Further, in some implementations, the tubular handle is angled or contoured to accommodate a preferred holding angle of the user. Still further, in some implementations an interface surface of the base structure contoured to interact compatibly with a structural feature of the tooth surface.

In some implementations, an outer surface of the tubular handle includes a cleat whereby the user secures the free end of the retention strap once the retention strap is adequately adjusted to secure the tooth against the base surface. In other implementations, the tubular handle includes a rotatable subsection having a spool, wherein the free end of the retention strap is wound around the spool upon rotating the subsection.

In some implementations an outer surface of the tubular handle includes a texture or coating to increase the friction between the tubular handle and the user's grip. In other implementations, the outer surface of the tubular handle includes an ergonomic feature to enhance the user's ability to grip the tooth removal device. Further, in some embodiments the base structure of the device is extended laterally so as to overlap teeth adjacent to the loose tooth.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. These drawings depict only typical embodiments of the invention and are not therefore to be considered to limit the scope of the invention.

FIG. 1 is a perspective front view of a tooth removal device in accordance with a representative embodiment of the present invention.

FIG. 2 is a cross-section view of a tooth removal device in accordance with a representative embodiment of the present invention.

FIG. 3 is a cross-section view of a tooth removal device as secured to a loose tooth in accordance with a representative embodiment of the present invention.

FIG. 4 is a cross-section view of a tooth removal device having a cleat feature in accordance with a representative embodiment of the present invention.

FIG. 5 is a cross-section view of a tooth removal device having a retention strap storage spool in accordance with a representative embodiment of the present invention.

FIG. 6 is a cross-section view of a tooth removal device in accordance with a representative embodiment of the present invention.

FIG. 7 is a cross-section view of a tooth removal device as secured to a loose tooth in accordance with a representative embodiment of the present invention.

FIG. 8 as shown in parts A through D is a cross-section side view of a tooth removal device having a retention strap routed external to the handle in accordance with various representative embodiments of the present invention.

FIG. 9 as shown in parts A through F is a side plan view of a base structure in accordance with various representative embodiments of the present invention.

FIG. 9, shown in parts G through I is a perspective view of a base structure and interface surface in accordance with various representative embodiments of the present invention.

FIG. 10 is a partially cross-section side view of a tooth removal device having an interface surface configure to accommodate a feature of a loose tooth in accordance with a representative embodiment of the present invention.

FIG. 11 as shown in parts A and B is a perspective front view of a tooth removal device in accordance with various representative embodiments of the present invention.

FIG. 12 is a perspective front view of a tooth removal device having a modified gripping surface in accordance with a representative embodiment of the present invention.

FIG. 13 is a perspective front view of a tooth removal device having an ergonomic gripping surface in accordance with a representative embodiment of the present invention.

FIG. 14 is a perspective front view of a tooth removal device having an extended base structure in accordance with a representative embodiment of the present invention.

FIG. 15 is a perspective side view of a tooth removal device having a scooped base structure in accordance with a representative embodiment of the present invention.

FIG. 16 is a perspective front view of a tooth removal device having a scooped base structure and mid-positioned openings in accordance with a representative embodiment of the present invention.

FIG. 17 is a perspective front view of a tooth removal device having a novelty handle resembling a character in accordance with a representative embodiment of the present invention.

### DETAILED DESCRIPTION OF THE INVENTION

The presently preferred embodiments of the present invention will be best understood by reference to the drawings, wherein like reference numbers indicate identical or functionally similar elements. It will be readily understood that the components of the present invention, as generally described and illustrated in the figures herein, could be arranged and designed in a wide variety of different configurations. Thus, the following more detailed description, as represented in the figures, is not intended to limit the scope of the invention as claimed, but is merely representative of presently preferred embodiments of the invention.

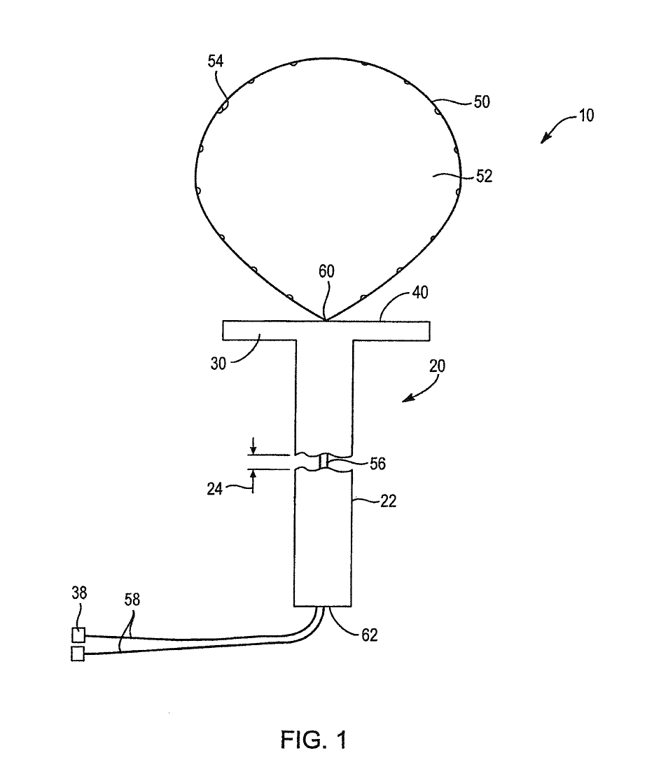

Referring now to FIG. 1, a loose tooth removal device 10 is shown. In general, a loose tooth removal device 10 in accordance with the present invention comprises a tubular handle 20 having a gripping surface 22 whereby a user grasps the device 10. In some embodiments, handle 20 comprises a rigid or semi-rigid polymer material, such as nylon, phenolic, epoxy, polypropylene, polystyrene, polyacetylene, and polycarbonate. In other embodiments, handle 20 comprises a rigid metallic material, as known in the art.

Handle 20 is generally manufactured by known methods in the art. Such methods may include injection molding, fusible core injection molding, extrusion molding, blow molding, die casting, machining, plastic welding, and metal welding. In some embodiments, handle 20 comprises a plurality of individual components joined with an adhesive or epoxy. In other embodiments, handle 20 comprises a plurality of individual components joined via mechanical connections.

The length of the handle 20 is generally configured to permit to the user to securely grip the device 10 during use. In some embodiments, handle 20 is pinched by the user. In other embodiments, handle 20 is grasped in the palm of the user's hand. Accordingly, the length 24 of handle 20 is adjusted to accommodate a desired gripping method.

In some embodiments, handle 20 comprises a base structure 30 having an interface surface 40 positioned opposite of gripping surface 22. Interface surface 40 is generally configured to accommodate an outer surface of a loose tooth. Thus, in some embodiments interface surface 40 comprises features and/or textures configured to accommodate structural features and textures of the tooth surface. For example, in some embodiments interface surface 40 comprises a moldable material, such as a wax, thermoplastic or other polymer material that may be prepared by the user to conform to the shape of the loose tooth. In some embodiments, interface surface 40 comprises a moldable material that is heated by the user, such as by placing the material in a heated liquid, and then pressed against a surface of the user's loose tooth to form an impression of the tooth surface in the moldable material. In some embodiments, the impression of the tooth surface in the moldable material customizes interface surface 40 to the patient's tooth which results in increased friction between the tooth and the device 10. In some embodiments, interface surface 40 is configured to increase friction between handle 20 and the tooth surface, as discussed in detail below.

In some embodiments, device 10 further comprises a retention strap 50. In general, retention strap 50 is provided as a means for securing a loose tooth against interface surface 40. In some embodiments, retention strap 50 comprises a cord or thread material having a length sufficient to form an adjustable loop 52 proximate to interface surface 40. In other embodiments, retention strap 50 comprises a band having a width approximately equal to or less than the height of the loose tooth.

Retention strap 50 generally comprises an inelastic or substantially inelastic material having a tensile strength sufficient to withstand forces required to remove the loose tooth. In some embodiments, retention strap 50 comprises a multi-filament material, such as nylon or a braided wire cable. In other embodiments, retention strap 50 comprises a mono-filament material, such polytetrafluoroethylene, nylon, or a solid wire.

In some embodiments, retention strap 50 further comprises a friction agent 54 provided to increase friction between retention strap 50 and the outer surface of a loose tooth. In some embodiments, friction agent 54 comprises a wax coating. In other embodiments, friction agent 54 comprises an abrasive powder imbedded within retention strap 50. Further, in some embodiments friction agent 54 comprises a tacky or rubbery polymer, such as a halogenated polymer material. In some embodiments, friction agent 54 is applied to an outer or exposed surface of retention strap 50. In other embodiments, friction agent 54 is embedded or infused within the material of retention strap 50. Further, in some embodiments friction agent 54 comprises an independent strand that is intertwined with the material of retention strap 50.

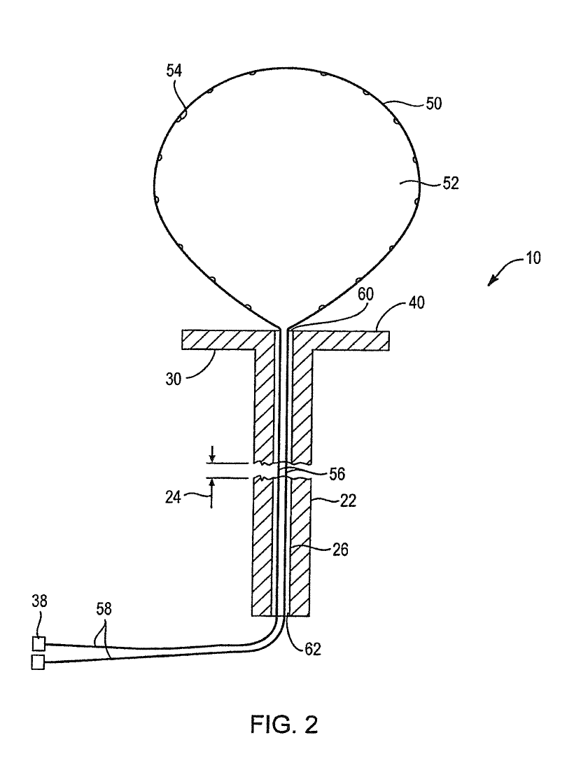

Referring now to FIGS. 1 and 2, adjustable loop 52 is formed by threading at least one free end 58 of retention strap 50 through tubular handle 20. Thus, a middle portion 56 of retention strap 50 is contained within a lumen 26 of handle 20, while loop 52 and free end 58 of retention strap 50 are positioned external to a first opening 60 and second opening 62 of handle 20, respectively. The diameter of loop 52 is adjusted by either advancing middle portion 56 out of first opening 60, or drawing loop 52 into lumen 26 by withdrawing middle portion 56 out of second opening 62 via free end 58. In some embodiments, free end 58 further comprises a bead or handle 38 whereby the user is able to grasp and control the position of free end 58. In some embodiments, bead 38 prevents free end 58 from being entirely drawn into lumen 26.

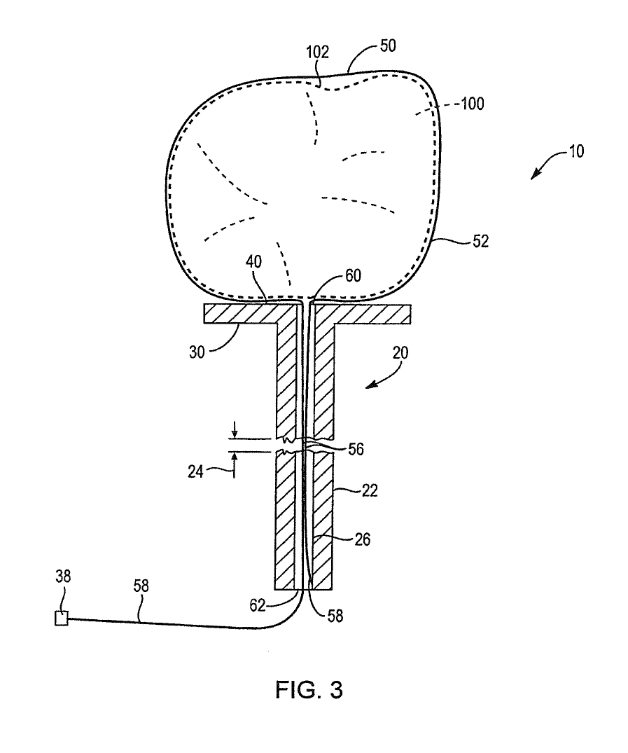

Referring now to FIG. 3, tooth removal device 10 is shown following securement of retention strap 50 and interface surface 40 to a loose tooth 100. In some embodiments, a first and second free end 58 of retention strap 50 is positioned external to lumen 26, as shown in FIGS. 1 and 2. In other embodiments, a first free end 58 of retention strap 50 is positioned external to lumen 26, while a second free end 58 is fixedly retained within lumen 26, as shown in FIG. 3. Thus, the diameter of loop 52 is increased or decreased by withdrawing or advancing free end 58 relative to lumen 26. This configuration provides the user with a single end 58 whereby to adjust and maintain a desired loop diameter.

Loose tooth 100 is secured to interface surface 40 by first placing loop 52 about an outer surface 102 of tooth 100. The diameter of loop 52 is then reduced by withdrawing middle portion 56 from lumen 26 via free end 58 and second opening 62. Upon tightening loop 52, the flexible or semi-flexible properties of retention strap 50 achieve a customized diameter reflective of the tooth's 100 outer surface 102 profile. For example, as the diameter of loop 52 is closed about outer surface 102, retention strap 50 conforms to positive features of outer surface 102, while spanning negative features. Thus, retention strap 50 may be used to secure and remove any tooth 100 regardless of size and surface features.

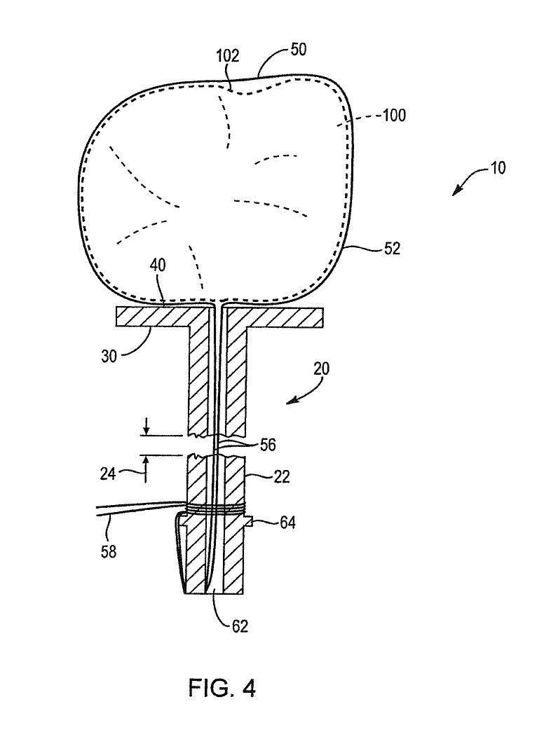

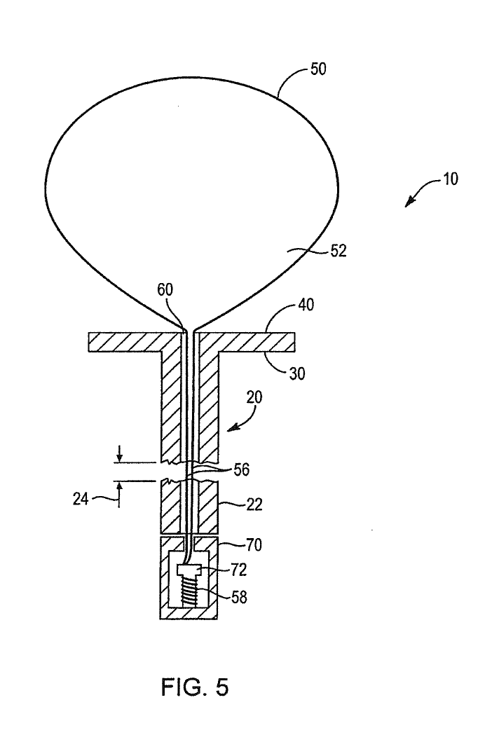

In some embodiments, the desired diameter of loop 52 is maintained by retaining free end 58 in the user's hand or fingers while manipulating device 10 relative to tooth 100. In other embodiments, handle 20 is modified to include a cleat 64 about which free end 58 is wound, as shown in FIG. 4. Still further, in some embodiments device 10 is modified to include a rotatably coupled retainer 70 having a storage spool 72, as shown in FIG. 5. Following placement of retaining strap 50 about tooth 100, retainer 70 is rotated relative to handle 20 thereby coiling free end 58 onto storage spool 72. When a desired diameter for loop 52 is achieved, the user maintains the desired diameter by gripping both the handle 20 and retainer 70. In some embodiments, a plurality of detents and ridges or bearings are interposed between retainer 70 and handle 20 so as to reversibly maintain the rotated position of the retainer 70 during use of the device 10.

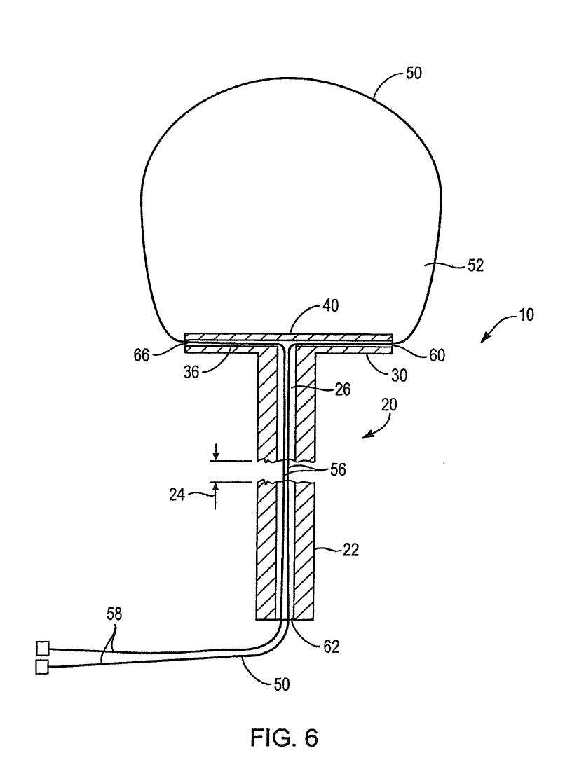

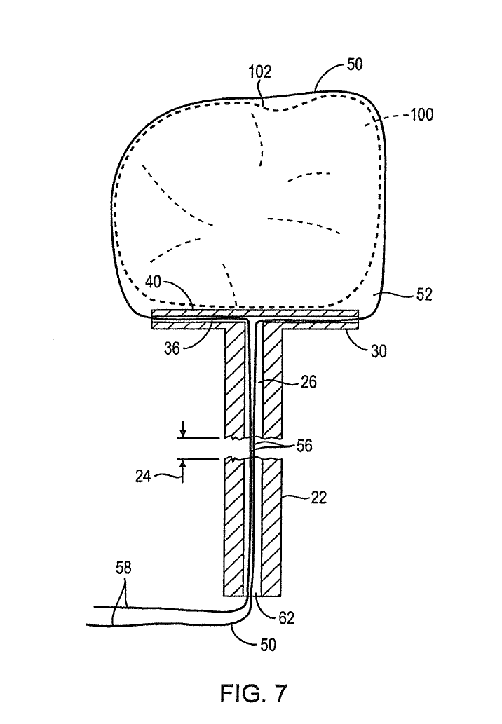

In some embodiments, base structure 30 comprises a tubular member having a lumen 36 in fluid communication with lumen 26 of handle 20, as shown in FIG. 6. Accordingly, in some embodiments retention strap 50 is threaded through lumen 36 and lumen 26 such that free ends 54 exit second opening 62 and loop 52 exits openings 66 of base structure 30. As thus configured, interface surface 40 combines with retention strap 50 to form loop 52. This configuration further serves to reduce tolerance between interface surface 40 and tooth 100, as shown in FIG. 7.

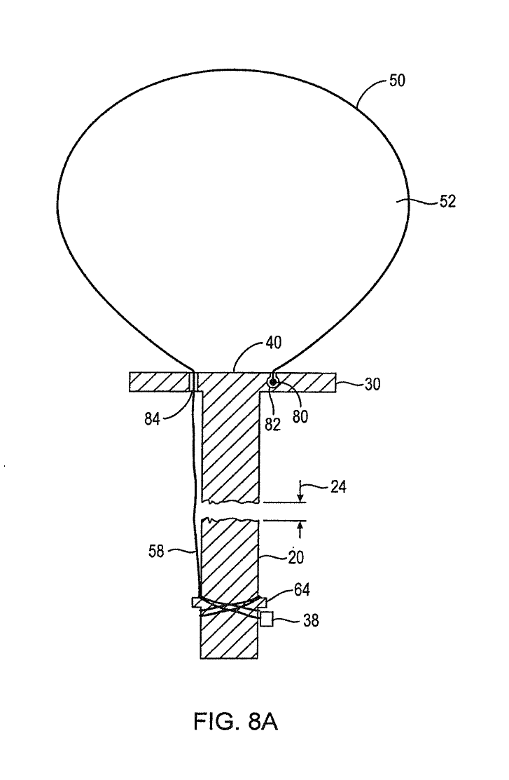

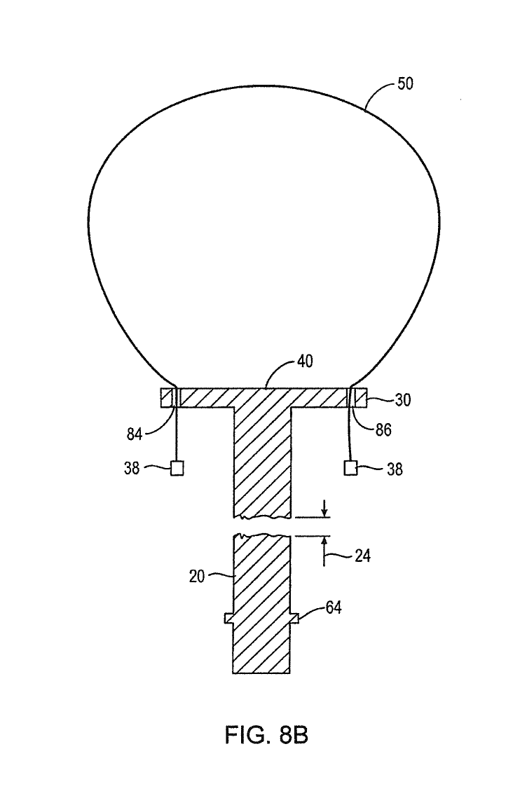

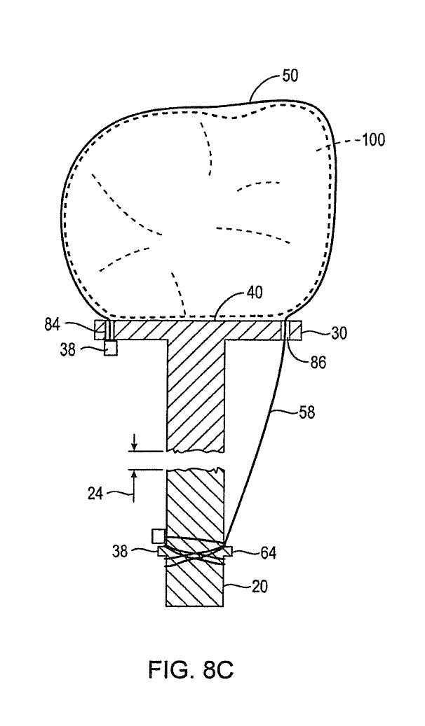

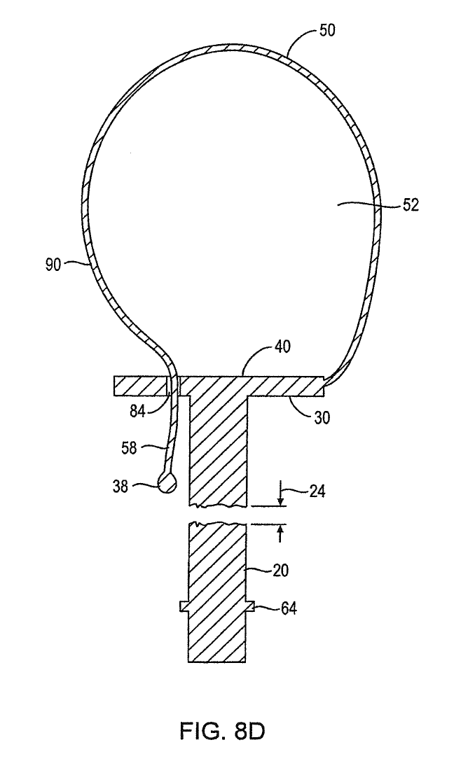

In some embodiments, lumen 26 of handle 20 is eliminated whereby retention strap 50 is routed external to handle 20, as shown in FIGS. 8A through 8C. With reference to FIG. 8A, a first end 80 of strap 50 is fixedly positioned within recess or cavity 82 of base structure 30. Retention strap 50 is further routed through access port 84 such that free end 58 is accessible to the user. In some embodiments, port 84 is provided in base structure 30 such that free end 58 is routed along handle 20 in close proximity. In other embodiments, port 84 is distanced from handle 20 so as to increase the distance between cavity 82 and port 84, thereby increasing the interface surface 40 interposed between the two features.

With reference to FIG. 8B, in some embodiments base structure 30 comprises a first port 84 and a second port 86 through which retention strap 50 is threaded. As thus configured, the user may adjust the diameter of loop 52 by pulling either of the beads 38, thereby causing the other bead 38 to bind on their respective port 84 (or 86), as shown in FIG. 8C. In some embodiments, the diameter of loop 52 is maintained by wrapping free end 58 around handle 20. In other embodiments, loop 52 is further maintained by wrapping free end 58 around cleat 64.

With reference to FIG. 8D, in some embodiments retention strap 50 comprises an extended portion of base structure 30, as shown. For example, in some embodiments base structure 30 is extended and tapered thereby providing a filament 90 having a diameter and tensile strength sufficient for securing a loose tooth 100 against interface surface 40. In some embodiments, filament 90 is molded concomitantly with handle 20 thereby providing a unitary device. In other embodiments, filament 90 is molded separate from handle 20 and subsequently attached to handle 20 by a known method, such as plastic welding, a mechanical coupling or an adhesive. Still further, in some embodiments base structure 30 is heated and pulled thereby forming filament 90. In some embodiments, free end 58 of filament 20 is passed through port 84 thereby forming loop 52.

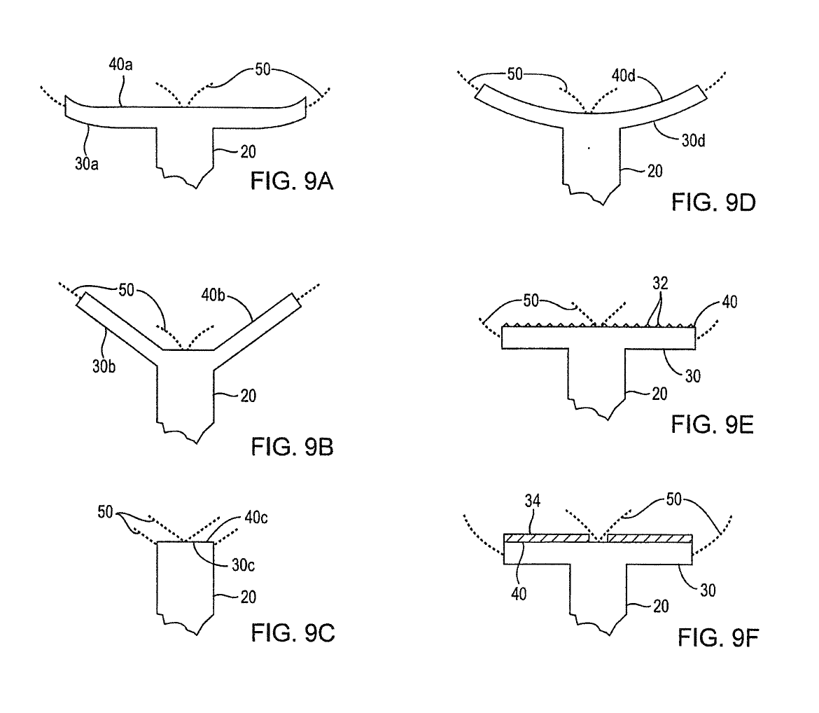

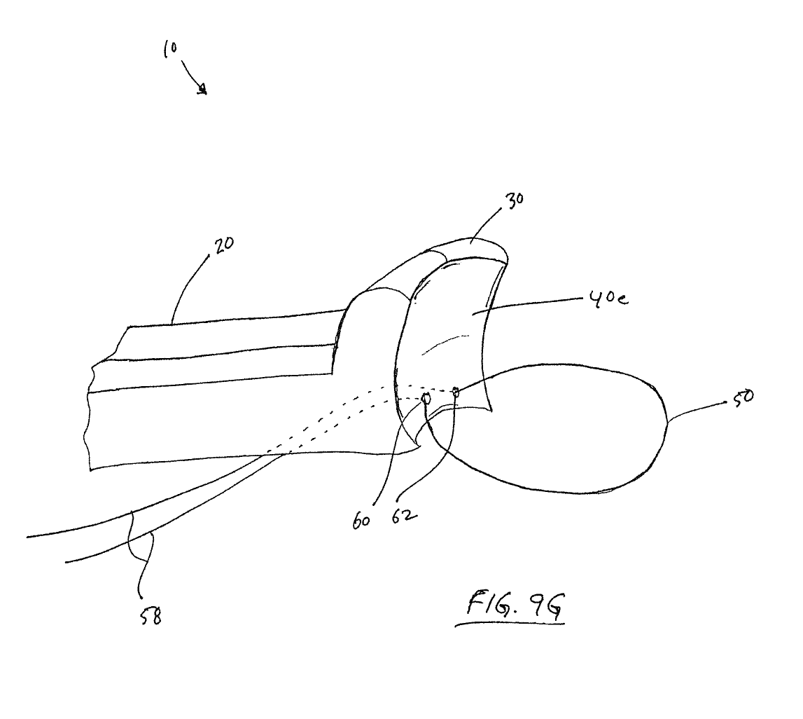

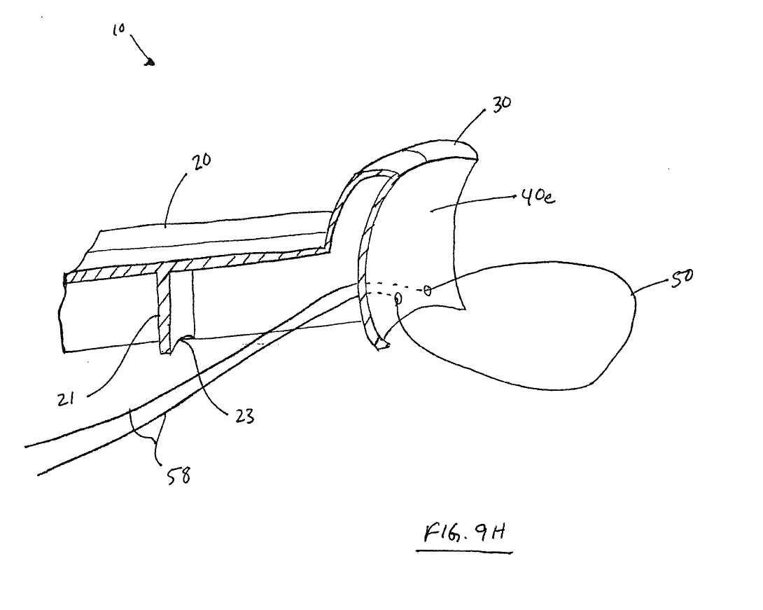

Referring now to FIGS. 9A through 9I, various representative embodiments of base structure 30 are shown. In some embodiments, base structure 30 is shaped or contoured to accommodate an outer surface 102 of loose tooth 100. For example, in some embodiments terminal ends of base structure 30a are curved inwardly such that interface surface 40a contours to the rounded corners of tooth 100. In other embodiments, base structure 30b and interface surface 40b comprise a y-configuration. Further in other embodiments, base structure 30c is less than, or approximately the same width as handle 20. Still further, in some embodiments base structure 30d curved such that interface surface 40d is contoured to more completely contact outer surface 102 of loose tooth 100.

In some embodiments, interface surface 40 is further modified to include a texture 32 or coating 34 to increase friction between device 10 and tooth 100. For example, in some embodiments interface surface 40 comprises a plurality of spikes 32, as shown in FIG. 9E. In other embodiments, interface surface 40 comprises a polymer coating 34, as shown in FIG. 9F.

In some embodiments, interface surface 40e comprises a double-concave surface that generally minors the outer surface of tooth 100, as shown in FIGS. 9G-9I. In other embodiments, interface surface 40e comprises a hemispherical, or three-dimensional concave surface. Interface surface 40e may further comprise other geometrical shapes, features and/or configurations as may be determined to best accommodate the outer surface of tooth 100. For example, interface surface 40 may comprise a wedge shape, a trapezoid shape, a rectangular shape, a circular shape, a triangular shape, a square shape, an oval shape, a diamond shape, or any other shape which is determined to compatibly interface with tooth 100. In some instances, interface surface 40 is configured to have a first width to interface with a first portion of tooth 100, and a second width to interface with a second portion of tooth 100.

In some instances, first and second openings 60 and 62 are located on a lower portion of interface surface 40e such that retention strap 50 is positioned around the base of tooth 100, adjacent the patient's gums. In some embodiments, device 10 comprises a hollow handle 20, such that free ends 58 are largely positioned external to handle 20, and are wrapped around handle 20 to secure and retain retention strap 50 around tooth 100. Device 10 may further include one or more cross-members or webbing 21 which increase the rigidity of handle 20, as shown in FIG. 9H. Cross-members 21 may further include an ergonomic surface 23 to accommodate a user's thumb or other portion of the user's hand when using device 10.

In other embodiments, device 10 comprises a solid handle 20, as shown in FIG. 9I. Solid handle 20 further comprises a retention strap channel 25 which provides a pathway for retention strap 50 through solid handle 20. Free ends 58 are thus threaded through first and second openings 60 and 62 and fed through channel 25, as shown. Free ends 58 are then positioned external to solid handle 20 where they may be wrapped around handle 20 to secure and retain retention strap 50 around tooth 100.

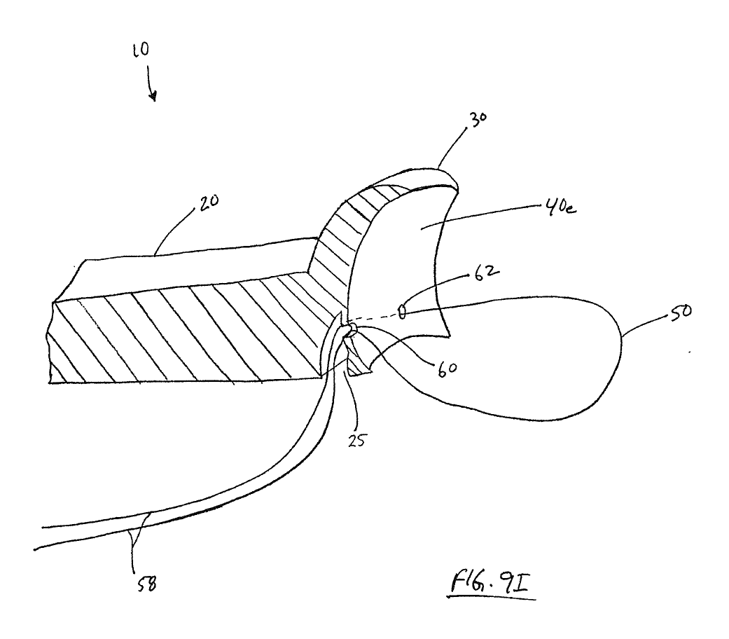

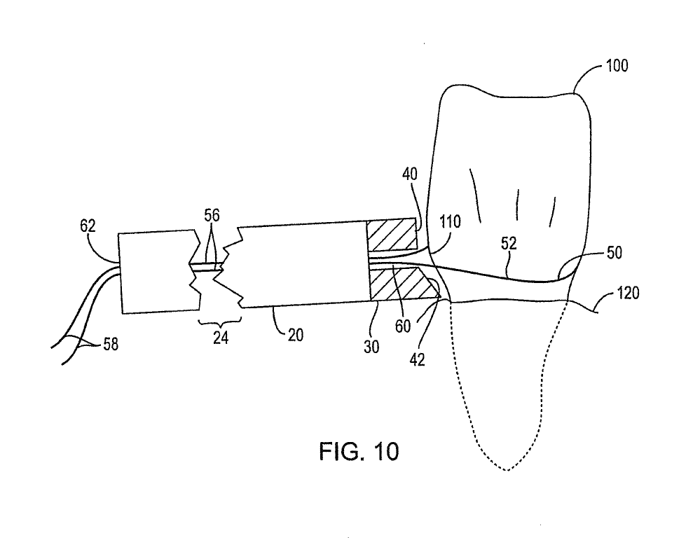

In some embodiments, interface surface 40 further comprises a feature configured to specifically interact with a known surface of tooth 100. For example, in some embodiments interface surface 40 comprises a chamfer 42 configured to compatibly engage a buccal bulge 110 surface of tooth 100, as shown in FIG. 10. Upon tightening loop 52, chamfer 42 forms an interface with buccal bulge 110 thereby securing chamfer 42 at a position adjacent to the patient's gums 120. The interface between chamfer 42 and bulge 110 insures proper placement and maintained positioning during removal of the tooth 100.

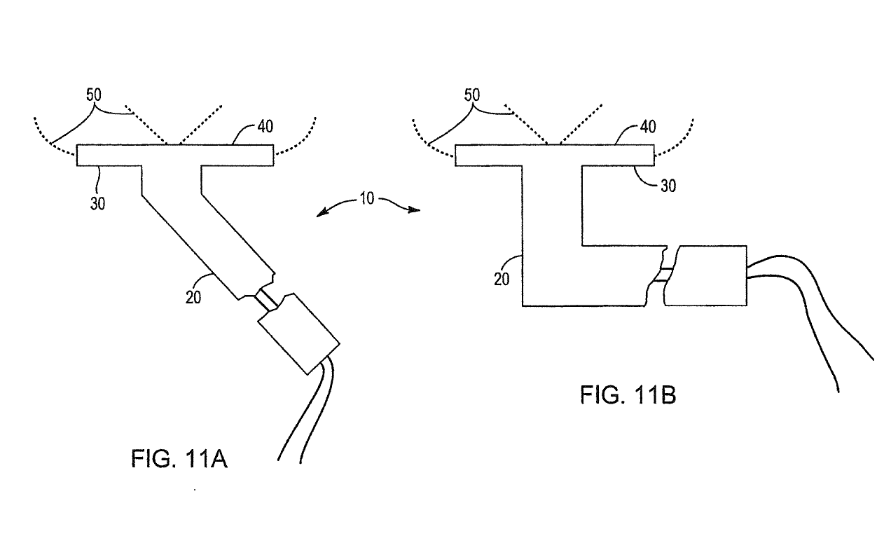

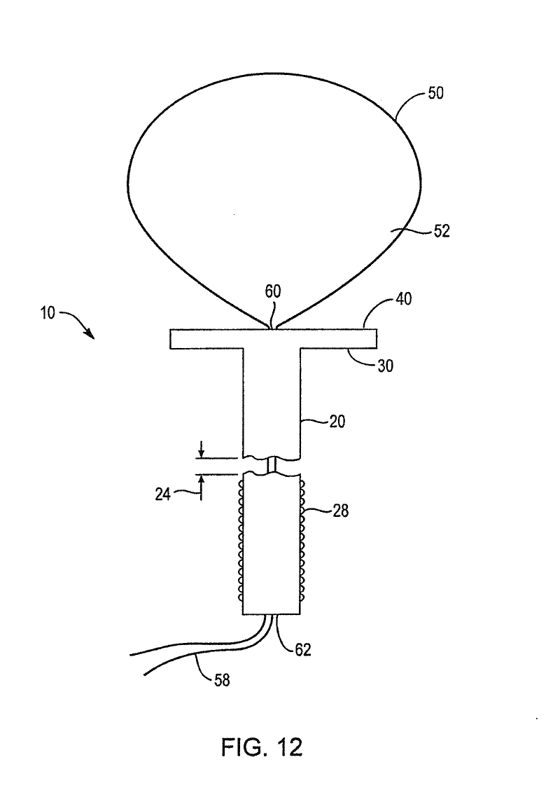

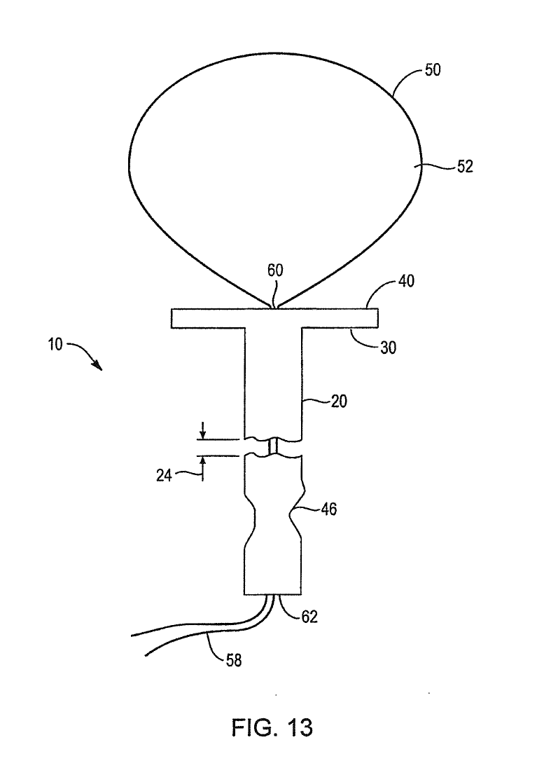

As previously mentioned, in some embodiments handle 20 is configured to further aid and assist a user in gripping the device 10. As shown in FIGS. 11A and 11B, in some embodiments handle 20 is angled or bent to accommodate a user in accessing an unreachable tooth. In other embodiments, handle 20 comprises a bendable material wherein a user is able to deform handle 20 to a desired configuration. In other embodiments, handle 20 includes a grip or texture 28 to increase friction between the user's grip and the handle 20, as shown in FIG. 13. Further, in some embodiments handle 20 comprises an ergonomic feature 46 configured to accommodate the user's hand or fingers in grasping the device 10.

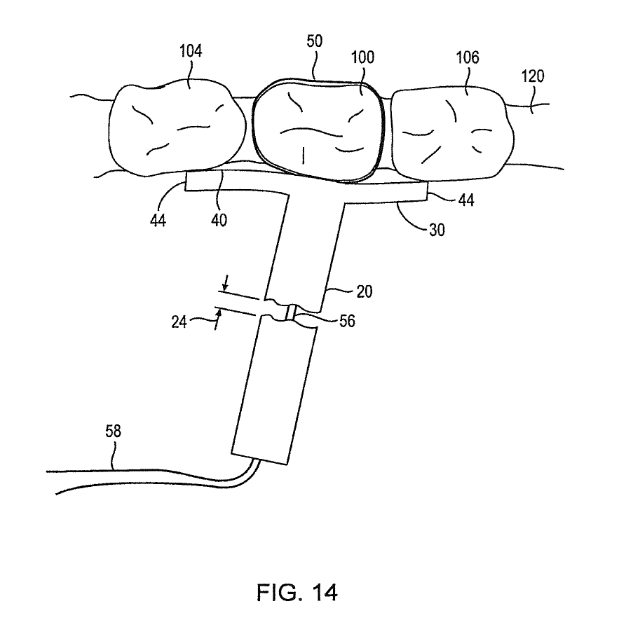

Interface surface 40 is generally configured to have a width approximately equal to or less than the width of loose tooth 100. However, in some embodiments interface surface is extended laterally such that terminal ends 44 partially overlap adjacent teeth 104 and 106, as shown in FIG. 14. The positions of terminal ends 44 provide a pivot point against which base structure 30 may be pivoted to increase the leverage of retaining strap 50 on loose tooth 100. Accordingly, in some embodiments the interaction between extended base structure 30 and adjacent teeth 104 and 106 increases the possible torque applied by retention strap 50 of tooth removal device 10.

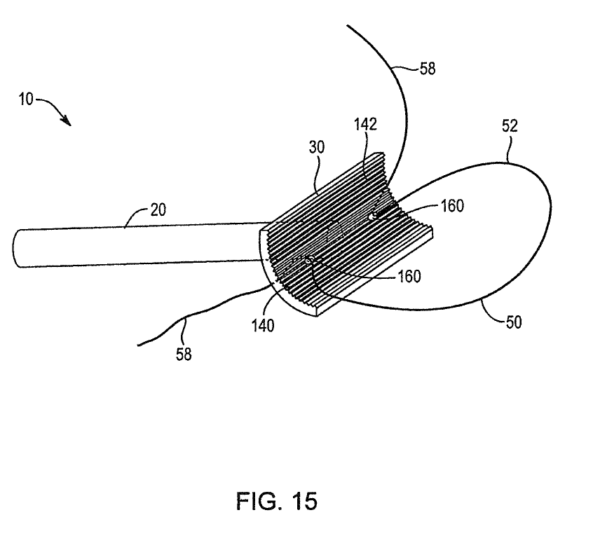

Referring now to FIG. 15, in some embodiments base structure 30 comprises a scoop, wherein interface surface 140 is generally concave. The concavity of surface 140 is provided to compatibly receive the generally non-planar outer surface of the patient's loose tooth. In some embodiments, interface surface 140 comprises a radius configured to compatibly interface with a buccal bulge surface of a tooth. In other embodiments, interface surface 140 further comprises a textural feature, such as a plurality of parallel grooves 142, as shown. Grooves 142 provide texture to surface 140 whereby to increase friction between surface 140 and the outer surface of the tooth.

In some embodiments, base structure 30 further comprises openings 160 located on interface surface 140 and forming apertures therethrough. Openings 160 are provided so as to accommodate passage of retention strap 50. Thus, adjustable loop 52 is formed adjacent to interface surface 140, and free ends 58 of strap 50 pass through openings 160 and are positioned adjacent to handle 20. Loop 52 is tightened around the patient's loose tooth as free ends 58 are pulled away from base structure 30 and either held by the user, or wrapped around handle 20, as previously discussed.

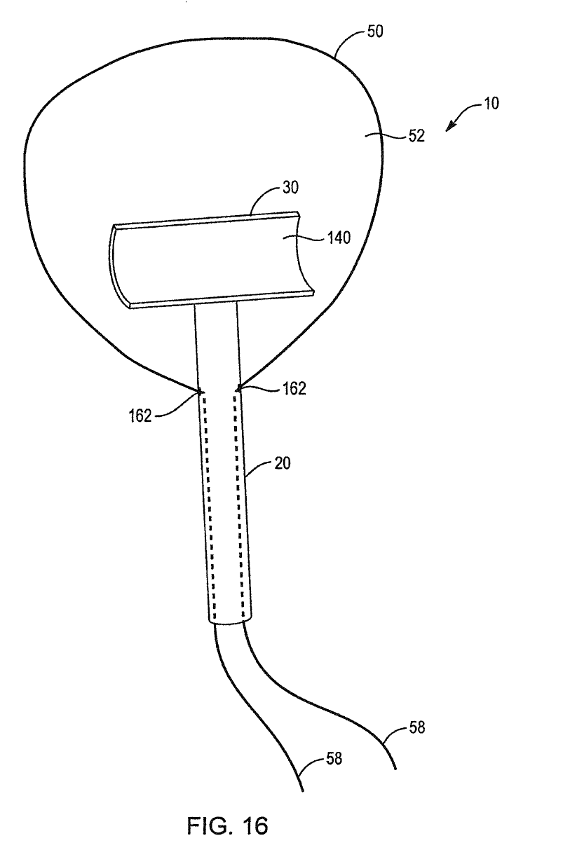

In some embodiments, openings 162 are positioned in handle 20, as shown in FIG. 16. Openings 162 lower the position of loop 52 thereby changing the specific mechanics by which retention strap 50 secures the patient's tooth to interface surface 140. For example, in some embodiments the lower position of openings 162 more evenly distributes contact pressure between the outer surface of the tooth and the entire interface surface 140. The lower position of openings 162 may further allow greater user flexibility in securing loop 52 around the patient's tooth, as the retention strap 50 is not directly coupled to base structure 30. Thus, in some embodiments the relationship between openings 162 and base structure 30 are configured to optimize contact between interface surface 140 and the patient's tooth.

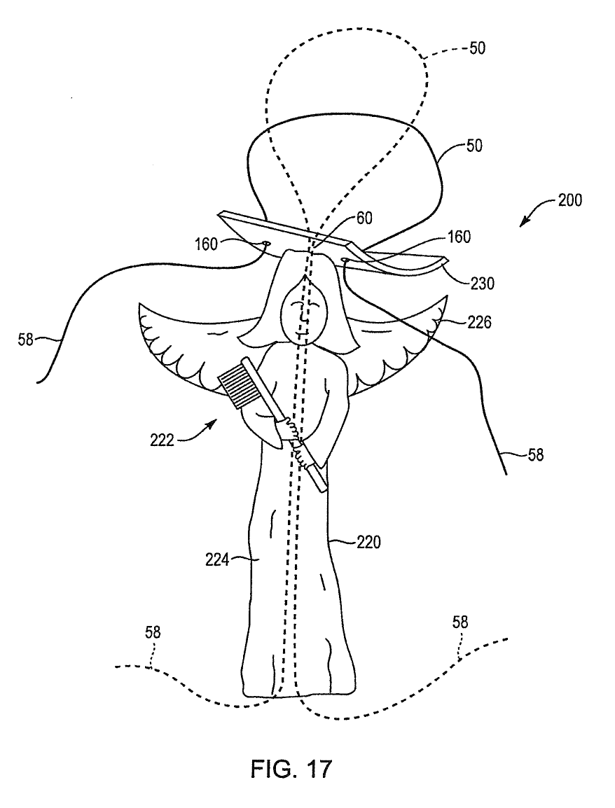

Referring now to FIG. 17, in some embodiments a novelty tooth removal device 200 is provided. Device 200 generally comprises a handle 220, a base structure 230, and a retention strap 50. In some embodiments, handle 220 further comprises a novelty handle having a decorative surface which resembles a character 222, such as a figurine, an animal, an object, a theme, and/or combinations thereof. For example, in some embodiments handle 220 resembles a tooth fairy.

In some embodiments, handle 220 is solid, wherein retention strap 50 is routed through openings 160 provided through base structure 230. In other embodiments, handle 220 is hollow, wherein retention strap 50 is routed at least partially through handle 220 and through an opening 60 provided through base structure 230. Further, in some embodiments handle 220 is at least partially hollow, wherein retention strap 50 is routed at least partially through handle 220 and through a plurality of openings (not shown) provided in handle 220.

In some embodiments, character 222 is a two-dimensional representation of a desired item. In other embodiments, character 222 is a three-dimensional representation of a desired item, as shown. In some embodiments, the decorative surface of handle 220 comprises only a portion of the handle, such that character 222 comprises only a portion of the handle 220. For example, in some embodiments a front surface of handle 220 comprises a three-dimensional character 222, and a back surface of handle 220 is undecorated. In other embodiments a front surface of handle 220 comprises a three-dimensional character 222, and a back surface of handle 220 is concave or inwardly molded to provide a negative impression, shape or image of character 222. Still further, in some embodiments a front surface of handle 220 comprises a three-dimensional character 222, and a back surface comprises a concave space which includes structures to increase the rigidity of handle 220, such as an I-beam, c-channel, or other molded structures.

In some embodiments, structural features of character 222 provide a utilitarian feature to device 200. For example, in some embodiments a structure feature or texture 224 of character 222 provides an ergonomic grip to handle 220. In other embodiments, a structural feature 226 of character 222 increases the overall width of device 220 thereby preventing any choking hazards otherwise associated with device 220. For example, in some embodiments a structural feature 230 of character 222 increases the overall width of device 200 from approximately 12.7 mm to approximately 51 mm.

Character 222 may also comprise an item or subject that is desirable to a child user. A child-friendly item or subject may decrease a child's anxiety and encourage the child to use the device 200. Further, in some embodiments device 200 comprises a keepsake, wherein following use of device 200 retention strap 50 is removed from the device 200 thereby providing a character keepsake for the child user. In other embodiments, device 200 further comprises a compartment wherein the child user may store their removed tooth. For example, the child user may store their removed tooth in the compartment preparatory to hiding device 200 under their pillow for the tooth fairy.

One of skill in the art will appreciate that the various features and elements of the various embodiments of the present invention may be modified and/or combined within the spirit of the present invention to provide an optimized loose tooth removal device. For example, the size, dimensions, shapes, proportions and materials of the present invention may be modified as desired or necessary to provide a user-compatible device. Thus, the present invention may be embodied in other specific forms without departing from its structures, methods, or other essential characteristics as broadly described herein and claimed hereinafter. Therefore, the described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed is:

1. A device for removing a loose tooth, the device comprising:
a handle having a first end and a second end;
a base structure forming the first end of the handle, the base structure having an interface surface; and
a retention strap coupled to a portion of the handle and forming an adjustable loop, wherein the adjustable loop secures a tooth against the interface surface of the base structure.

2. The device of claim 1, wherein the handle further comprises a first opening, a second opening, a portion of the retention strap being positioned in the first and second openings.

3. The device of claim 2, wherein the handle further comprises a lumen extending between the first and second openings, a portion of the retention strap being positioned within the lumen.

4. The device of claim 3, the retention strap further having a free end located external to the lumen and adjacent to the first end.

5. The device of claim 3, the adjustable loop being located external to the lumen and adjacent the second end.

6. The device of claim 3, wherein the retention strap further comprises a middle portion disposed within the lumen.

7. The device of claim 1, wherein the interface surface is concave.

8. The device of claim 1, wherein the interface surface is textured.

9. The device of claim 2, wherein the first and second openings are located in the base structure.

10. The device of claim 2, wherein the first and second openings are located in a middle portion of the handle.

11. The device of claim 1, wherein the handle further comprises a decorative surface.

12. The device of claim 11, wherein the decorative surface comprises a character.

13. A method for manufacturing a device for removing a loose tooth, the method comprising:
providing a handle having a first end and a second end;
attaching a base structure to the second end of the handle, the base structure having an interface surface;
attaching a retention strap to a portion of at least one of the handle and the base structure; and
forming a portion of the retention strap into an adjustable loop, wherein the adjustable loop secures a tooth against the interface surface of the base structure.

14. The method of claim 13, further comprising:
providing a first opening in the handle;
providing a second opening in the handle; and
positioning a portion of the retention strap in the first and second openings.

15. The method of claim 14, further comprising a step for providing a lumen extending between the first and second openings, a portion of the retention strap being positioned within the lumen.

16. A device for removing a loose tooth, the device comprising:
a handle having a first end and a second end;
a base structure attached to the second end of the handle, the base structure having an interface surface;
a first and second opening formed in the base structure; and
a retention strap threadedly inserted through the first and second openings, the retention strap forming an adjustable loop adjacent the interface surface, wherein a free end of the retention strap is pulled to adjust a size of the adjustable loop.

17. The device of claim 16, wherein the interface surface is textured.

18. The device of claim 16, wherein the interface surface is concave.

19. The device of claim 16, wherein the base structure is scooped.

20. The device of claim 16, wherein the handle comprises an ergonomic grip.
